(19) United States
(12) Patent Application Publication
(10) Pub. No.: US 2019/0171689 A1
(43) Pub. Date: Jun. 6, 2019

(54) OPTIMIZING ITEM DISPLAY ON GRAPHICAL USER INTERFACES

(71) Applicant: GOOGLE LLC, Mountain View, CA (US)

(72) Inventors: Ahmed Kachkach, Mountain View, CA (US); Yi-fan Chen, Sunnyvale, CA (US); Karthik Lakshmanan, Fremont, CA (US); Sally Goldman, Los Altos Hills, CA (US); Puneet Chopra, San Francisco, CA (US); Radhika Malpani, Palo Alto, CA (US); Jeremy Shute, Yarmouth, ME (US); Berna Erol, Saratoga, CA (US)

(21) Appl. No.: 16/211,209

(22) Filed: Dec. 5, 2018

Related U.S. Application Data
(60) Provisional application No. 62/594,901, filed on Dec. 5, 2017.

(51) Int. Cl. G06F 16/9538; G06F 3/0482; G06F 16/2457; G06F 16/28; G06F 16/9535

(52) U.S. Cl. CPC G06F 16/9538; G06F 3/0482; G06F 16/9535; G06F 16/285; G06F 16/24578

(57) ABSTRACT

A search computing system receives an interaction history for one or more respective users describing interactions with one or more items and generates a co-interaction matrix, each value in the co-interaction matrix representing a number of common users determined to have had the interaction with an item of a corresponding row and an item of the corresponding column of the co-interaction matrix where the value is located. The search computing system generates an embeddings matrix comprising an item embedding value for each of the one or more items by applying matrix factorization to the co-interaction matrix and determines, in response to a search query of a particular user, a user embedding value for the searching user based on the interaction history for the searching user. The search computing system determines a similarity between each search result and user interaction history by comparing the user embedding value against each of the item embedding values.

### CROSS-REFERENCE TO RELATED APPLICATION

This patent application claims priority to U.S. Patent Application No. 62/594,901, filed Dec. 5, 2017 and entitled “Graphical User Interface Rendering Results from Overlapping Inputs.” The entire contents of the above-identified application are hereby fully incorporated herein by reference.

### TECHNICAL FIELD

The technology disclosed herein relates to optimizing display of items on a graphical user interfaces.

### BACKGROUND

Quantities of searchable items are large but only a small subset is shown to users in item search services. When items are relevant to a user's search query, item providers tailor search results to user preferences on many dimensions. Some item search services offer filters to help users select a more appropriate subset of items. This conventional approach has multiple drawbacks. For example, two or more items with the same rating may have drastically different rating standards. Certain information used in the filtering process is sparsely available, and often from untrusted sources. Initial search results include a wide array of item options. Many search and recommendation platforms utilize user history and behavior as a basis to recommend relevant items of interest. However, this conventional approach does not directly apply for all types of items. A typical user might utilize certain items or services once or twice a year, whereas other items may be accessed or used ten times in one day. Users are also constrained by personal factors, and their exploration will usually be restricted to items that fall within those personal factors.

Conventional approaches for generating search results do not provide for creating user specific embeddings for display via graphical user interfaces.

### SUMMARY

Techniques herein provide computer-implemented methods to optimize item displays on a graphical user interface. For example, a search computing system receives a request to render a listing of item entries on a user interface of a user computing device; the search computing system analyzes first item type interaction histories to determine item embedding values by: receiving the first item type interaction histories for each of two or more users, the first item type interaction histories describing one or more interactions of a first kind by each of the two or more users with one or more items of a first item type; generating a co-interaction matrix comprising rows and columns corresponding to each of the one or more items and matrix element values each representing a number of users determined to have the first kind of interaction with a row item of the corresponding row and a column item of the corresponding column within the co-interaction matrix; generating an embeddings matrix comprising an item embedding value for each of the one or more items; and extracting the item embedding value for each of the one or more items from the embeddings matrix. The search computing system analyzes the first item type interaction histories to generate a user embedding value based on the first item type interaction history for a user associated with the user computing device. The search computing system generates the listing of item entries on the user interface of the user computing device by: identifying each of the item entries that are responsive to the request to render the listing of item entries, the item entries comprising one or more corresponding items; retrieving the item embedding value for each of the one or more item results; determining similarity values corresponding to a similarity between the determined item embedding value for each of the one or more items and the generated user embedding value; and ranking the one or more item results based on the determined similarity values, the ranking of the one or more item results comprising a preferred first item in a first position. The search computing system renders an optimized display of the one or more item results on the user interface of the user computing device, the optimized display comprising the preferred first item in the first position with each remaining item of the ranked one or more item results in a corresponding ranked non-first position.

In certain other example aspects described herein, systems and computer program products to optimize item display on a graphical user interface are provided.

These and other aspects, objects, features, and advantages of the examples will become apparent to those having ordinary skill in the art upon consideration of the following detailed description of illustrated examples.

### BRIEF DESCRIPTION OF THE DRAWINGS

FIG. 1 is a block diagram depicting a system to optimize item display on a graphical user interface, in accordance with certain examples.

FIG. 2 is a block flow diagram depicting a method for creating user embeddings for generating search results, in accordance with certain examples.

FIG. 3 is a block flow diagram depicting a method for registering, by a user, for an account with a search computing system, in accordance with certain examples.

FIG. 4 is an example illustration 400 of logged hotel interaction history for multiple users, in accordance with certain examples.

FIG. 5 is a block flow diagram depicting a method for generating, by a search computing system, user embeddings from an item interaction history of one or more users, in accordance with certain examples.

FIG. 6 is an example illustration 600 of a co-interaction matrix, in accordance with certain examples.

FIG. 7 is an example illustration 700 of a hotel embeddings matrix, in accordance with certain examples.

FIG. 8 is a block flow diagram depicting a method for determining, by a search computing system, search results in response to receiving search queries, in accordance with certain examples.

FIG. 9 is an example illustration 900 of similarity matrices, in accordance with certain examples.

FIG. 10 is a block diagram depicting a computing machine and module, in accordance with certain examples.

### DETAILED DESCRIPTION OF EXAMPLES

### Overview

The examples described herein provide computer-implemented techniques to optimize item display on a graphical user interface. In an example, a search computing system provides an optimized graphical user interface display of item recommendations in response to a user's search query by considering an item interaction history for the user as well as aggregated item interaction histories for multiple other users. A search computing system receives a first item type interaction history for each of one or more user accounts associated with one or more respective users. The interaction history describing one or more interactions of a first kind by each of the one or more users with one or more items of a first item type. The search computing system generates, a co-interaction matrix based on the received first item type interaction history. Each value in co-interaction the matrix represents a number of users determined to have the first kind of interaction with an item of the corresponding row and an item of the corresponding column of the co-interaction matrix. The search computing system generates an embeddings matrix comprising an item embedding for each of the one or more items and extracts an item embedding for each of the one or more items. The search computing system periodically generates subsequent embeddings matrices from which to extract item embeddings.

The search computing system receives a search query from a user computing device associated with the particular user. The search query comprises one or more search parameters. The search computing system generates a user embedding based on the first item type interaction history for the particular user. The search computing system determines a similarity value for each of one or more item search results responsive to the query. The similarity value corresponds to a similarity between the corresponding item embedding and the user embedding for the particular user. The search computing system ranks the one or more item search results based on the determined similarity values and transmits the one or more ranked item search results to the user computing device associated with the particular user with instructions that enable the user computing device to display the one or more ranked item search results. The search computing system provides an optimized display of item search results by emphasizing item search results that are relevant to the user based on the similarity values. For example, relevant search results comprise search results corresponding to item embeddings having a similarity value above a predefined threshold similarity value, item embeddings for a group of a predefined number having the highest similarity values, item embeddings having attributes corresponding to one or more user preferences that also exceed a predefined threshold similarity values, or other measures of relevance to the user. In an example, the most relevant search results are emphasized by being placed in a first or top-most location in a listing of search results. In an example, the most relevant search results are annotated in the listing of search results with text and/or user interface objects indicating to the user that the search result is relevant. For example, one or more search results comprise text annotation reading “best result” or comprise a user interface object comprising a star next to the search result. An example user interface display of search results comprises a display of a search result along an explanation that reads “This search result is a X % match,” wherein the value for X is determined based on a similarity value for the item embedding corresponding to the search result. In another example, one or more search results are emphasized with an explanation as to why the respective search result appears in the listing of search results. An example user interface display comprises a first search result and an explanation that reads “Because you purchased/reserved item Z” or “Because you searched for item Z,” “Because you have preference A and preference B,” indicating a largest contributing factor to the appearance of the search result in the listing of search results.

By using and relying on the methods and systems described herein, the search computing system and the user computing device provide the capability to provide user specific item search results corresponding to past user interactions with items and user preferences. By using and relying on the methods and systems described herein, the search computing system generates item embeddings comprising a representation of items as a vector of floating point numbers, which represents each item's characteristics in a low-dimensional space, enabling the comparison of items via a distance metric between item embeddings. As such, the systems and methods described herein may enable determination of similarity of items in search results to each other with reduced processing by the search computing system. By using and relying on the methods and systems described herein, the search computing system generates, in response to receiving search queries from users, user embeddings for searching users based on past user interactions with items, enabling the comparison of similarity of preferences of the user to characteristics of one or more items. As such, the systems and methods described herein may enable determination of similarity of items in search results to preferences of users while reducing processing by the search computing system.

By using and relying on the methods and systems described herein, the system to optimize item presentation provides improvements and enhancements over conventional systems, for instance by improving the way the data is processed to address a complex combinatorial problem. The search computing system processes multiple streams of data, multiple user parameters, multiple user item interaction histories, and multiple item inventories, to determine the optimized presentation of items. In order to adequately search, identify, and present item search results for presentation from such a complex data set, efficient computer methods for analyzing the data set are needed. The system improves computer functionality by improving the way the data is processed to address the complex combinatorial problem and to improving computer functionality by reducing the complexity of the data set such that it can be analyzed using more computationally efficient bitwise operations.

Various examples will be explained in more detail in the following description, read in conjunction with the figures illustrating the program flow.

### Example System Architecture

Turning now to the drawings, in which like numerals indicate like (but not necessarily identical) elements throughout the figures, examples are described in detail.

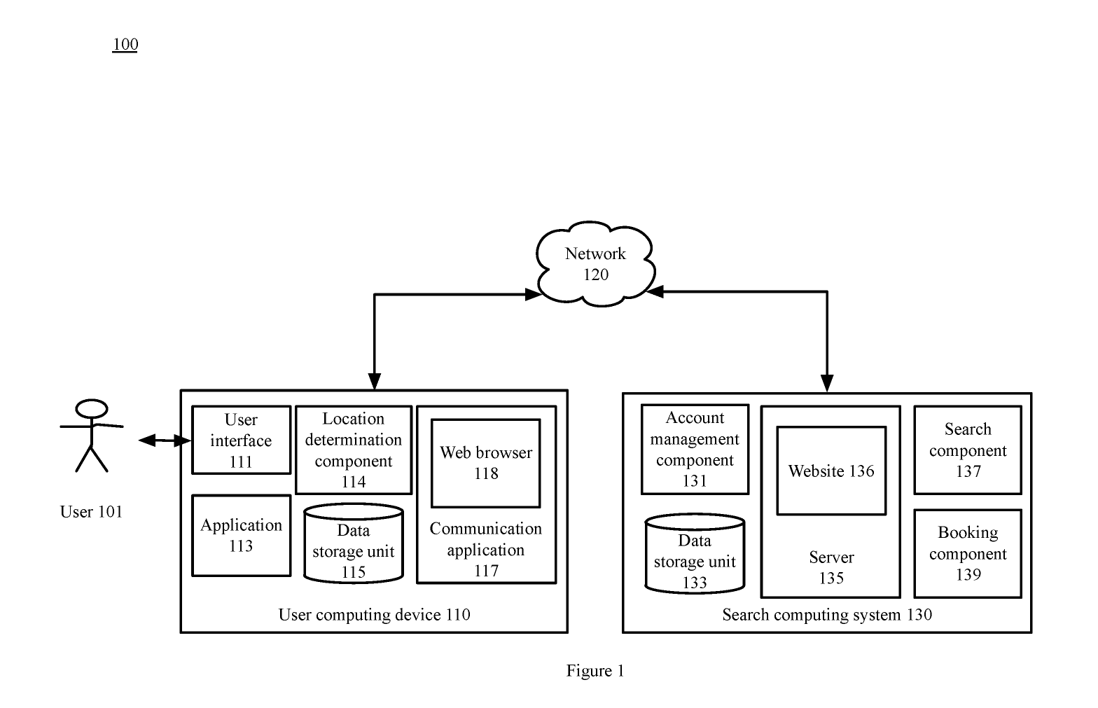

FIG. 1 is a block diagram depicting a system 100 for optimizing item display on a graphical user interface, in accordance with certain examples. As depicted in FIG. 1, the system 100 includes network computing devices 110, 130, 140, and 150 that are configured to communicate with one another via one or more networks 120. In some examples, a user associated with a device must install an application and/or make a feature selection to obtain the benefits of the techniques described herein.

In examples, the network 120 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, Bluetooth low energy (“BLE”), near field communication (“NFC”), ultrasound communication, or any combination thereof or any other appropriate architecture or system that facilitates the communication of signals, data, and/or messages. Throughout the discussion of examples, it should be understood that the terms “data” and “information” are used interchangeably herein to refer to text, images, audio, video, or any other form of information that can exist in a computer-based environment.

Each network computing device 110 and 130 includes a device having a communication module capable of transmitting and receiving data over the network 120. For example, each network computing device 110 and 130 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example depicted in FIG. 1, the network computing devices 110 and 130 are operated by users 101 and search computing system 130 operators, respectively.

In an example, a user 101 can search for one or more items on a user computing device 110. An example user computing device 110 comprises a user interface 111, an application 113, a location determination component 114, a data storage unit 115, a communication application 117, and a web browser 118. In an example, the user computing device 110 may be a personal computer, mobile device (for example, notebook, computer, tablet computer, netbook computer, personal digital assistant (PDA), video game device, GPS locator device, cellular telephone, Smartphone or other mobile device), television, wearable computing devices (for example, watches, rings, or glasses), or other appropriate technology that comprises or is coupled to a web server (or other suitable application for interacting with web page files) or that comprises or is coupled to an application 113.

The user 101 can use the user computing device 110 to search for items and to view an optimized display of item search results and/or item recommendations via the user interface 111 and the application 113 or 118. In an example, the user interface 111 enables the user 101 to interact with the user computing device 110. For example, the user interface 111 may be a touch screen, a voice-based interface, or any other interface that allows the user 101 to provide input and receive output from an application 113 on the user computing device 110. In an example, the user 101 interacts with the application 113 via the user interface 111.

In an example, the application 113 is a program, function, routine, applet, or similar entity that exists on and performs its operations on the user computing device 110. For example, the application 113 comprises one or more of a search application, an Internet browser 118, a user interface 111 application, or other suitable application operating on the user computing device 110. In certain examples, the user 101 must install the application 113 and/or make a feature selection on the user computing device 110 to obtain the benefits of the techniques described herein. In an example, the user 101 accesses the application 113 on the user computing device 110 via the user interface 111. In an example, the application 113 is associated with the search computing system 130.

In an example, the location determination component 114 comprises a global positioning system (“GPS”) component or other component that is able to determine a location of the user computing device 110. In an example, the location determination component 114 determines a current location of the user computing device 110 at a time the user 101 submits a search query to the search computing device 130 comprising a longitude and a latitude and transmits the search coordinates to the search computing system 130 along with the search query via the network 120. The user 101 configures one or more user 101 account settings via the application 113 to grant permission to the search computing system 130 to receive location data of the user computing device 110 and/or revoke permission for the search computing system 130 to receive user computing device 110 location data. In an example, the location determination component 114 communicates location data to the application 113 in accordance with one or more settings configured by the user 101.

The data storage unit 115 enables storage of one or more user 101 preferences for a user 101 account. For example, the data storage unit 115 stores one or more preferences of the user 101 in a user 101 profile for use in a search query. In an example, the data storage unit 115 comprises a local or remote data storage structure accessible to the user computing device 110 suitable for storing information. In an example, the data storage unit 115 stores encrypted information, such as HTML5 local storage.

In an example, the user computing device 110 uses a communication application 117, such as a web browser 118 application or a stand-alone application 113, to view, download, upload, or otherwise access documents or web pages via a distributed network 120

An example communication application 117 can interact with web servers or other computing devices connected to the network 120, including the server 135 associated with a search computing system 130.

In an example, the user 101 communicates with the search computing system 130 using the application 117 and the user interface 111. An example search computing system 130, or service processing system, comprises an account management component 131, a data storage unit 133, a server 135, a search component 137, and a booking component 139. An example server 135 communicates with the user computing device 110 to display a graphical user interface display of the website 136 via the user interface 111 of the user computing device 110. In an example, the user 101 manipulates one or more user interface 111 elements displayed on the graphical user interface display via the user interface 111 of the user computing device 110 to submit an item search query comprising one or more terms or to select one or more displayed items in a listing of items. In an example, the listing of items comprises, for each displayed item, a title of the item, a description of the item, one or more user interface 111 objects associated with the item, and an explanation for why the item is listed.

An example search computing system 130 comprises an account management component 131, a data storage unit 133, a server 135, a website 136, a search component 137, and a booking component 139.

In an example, the account management component 131 manages user 101 accounts and merchant computing system accounts associated with users 101 and merchants, respectively. The account management component 131 receives requests to add, edit, delete, or otherwise modify payment account information for a user 101 account, merchant computing system account, or other appropriate account.

In an example, the data storage unit 133 enables storage of item interaction histories for the user 101 and one or more other users 101 for retrieval by the search computing system 130. In an example, the search component 137 periodically stores and/or retrieves item interaction histories from the data storage unit 133. In an example, the data storage unit 133 comprises a local or remote data storage structure accessible to the search computing system 130 suitable for storing information. In an example, the data storage unit 133 stores encrypted information, such as HTML5 local storage.

An example server 135 provides content accessible by the user 101 through the web browser 118 and/or application 113 on the user computing device 110, including but not limited to html documents, images, style sheets, and scripts. In an example embodiment, the web server 135 supports the search computing system website 136.

An example website 136 comprises a search website of the search computing system 130. In example, the search computing system 130 receives search queries from user computing devices 110 over the network 120 via the website 136. In an example, the website 136 communicates, via the network 120 to the user computing device 110, instructions to display, via the application 113 or web browser 118 and user interface 111 of the user computing device 110, an optimized graphical display of item listings in response to receiving a user 101 search query.

An example search component 137 receives and/or logs hotel interaction histories of one or more users 101 and receives user computing device 110 data including location data of user computing devices 110 of one or more users 101. For example, the search component 137 receives, from the user computing device 110, location data logged by a location determination component 114 of the user computing device via the network 120. In an example, the search component 137 determines item embeddings based on the item interaction histories of the one or more users 101 and determines user 101 specific embeddings for the one or more users 101. For example, the search component 137 determines hotel embeddings based on the hotel interaction histories of the one or more users 101 and determines user 101 specific embeddings for the one or more users 101. In an example, the search component 137 receives a hotel search query from a user computing device 110 associated with a user 101, determines candidate hotel search results, and calculates a similarity of each hotel embedding corresponding to each candidate search result to the particular user's user 101 specific embedding. In an example, the search component 137 ranks the search results based on the determined similarity values and transmits the search results to the particular user computing device 110 for display via the particular user computing device 110. In an example, the search component 137 communicates with one or more of the data storage unit 135, the website 136, the server 135, booking component 139 and the account management component 131 to send and/or receive data.

In an example, the booking component 139 receives transaction details from a user computing device 110 and payment information associated with a user 101 payment account. In another example, the booking component 139 receives transaction details from a merchant computing system, payment information associated with a user 101 payment account and a merchant account. In an example, the transaction processing component 139 transmits a payment authorization request to an issuer system through an acquirer system or other appropriate financial institution associated with the user 101 payment account information. An example payment authorization request comprises merchant computing system payment account information, user 101 payment account information, and a total amount of the transaction. An example transaction involves a user 101 booking a hotel. In an example, after the issuer system processes the payment authorization request, the booking component 139 receives an approval or denial of the payment authorization request from the issuer system. In an example, the booking component 139 transmits a receipt to the user computing device 110 comprising a summary of the payment transaction. In another example, the booking component 139 logs one or more indications of user 101 interest in one or more services. For example, the booking component 139 logs one or more indications of user 101 interest in booking one or more hotels. For example, the booking component logs user 101 selections of hotels in search results, logs user 101 additions of hotels to a user 101 wish list, logs user 101 stays at hotels based on received user computing device 110 location data, logs user 101 reservations of hotels based on reservation data determined from parsed email data. For example, logging a reservation comprises logging that the user has completed required number of interactive steps with a hotel search result.

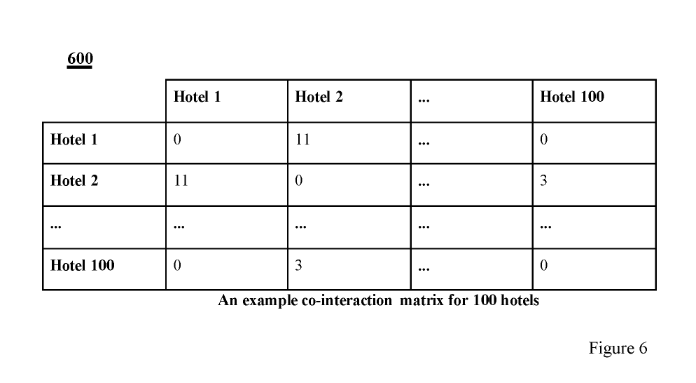

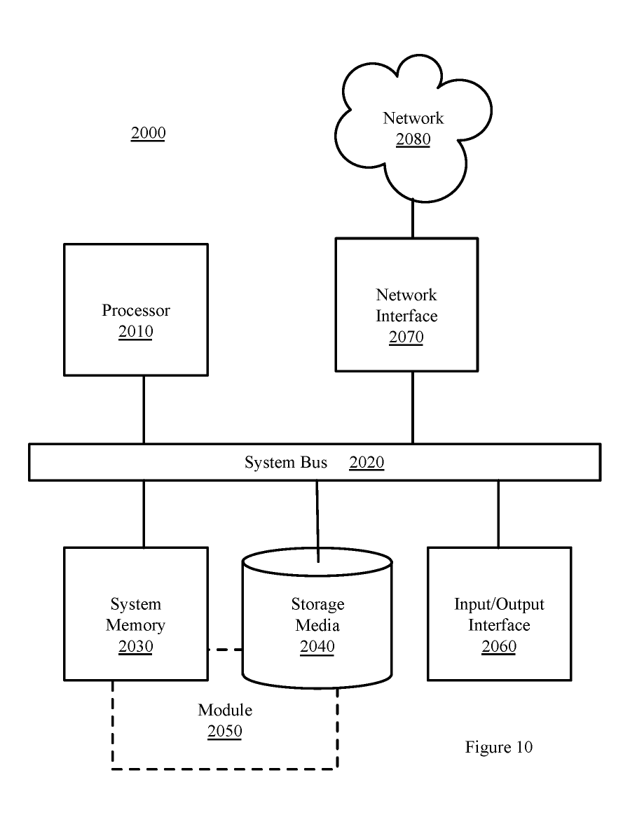

In examples, the network computing devices and any other computing machines associated with the technology presented herein may be any type of computing machine such as, but not limited to, those discussed in more detail with respect to FIG. 6. Furthermore, any functions, applications, or components associated with any of these computing machines, such as those described herein or any others (for example, scripts, web content, software, firmware, hardware, or modules) associated with the technology presented herein may by any of the components discussed in more detail with respect to FIG. 10. The computing machines discussed herein may communicate with one another, as well as with other computing machines or communication systems over one or more networks, such as network 120. The network 120 may include any type of data or communications network, including any of the network technology discussed with respect to FIG. 10.

### Example Processes

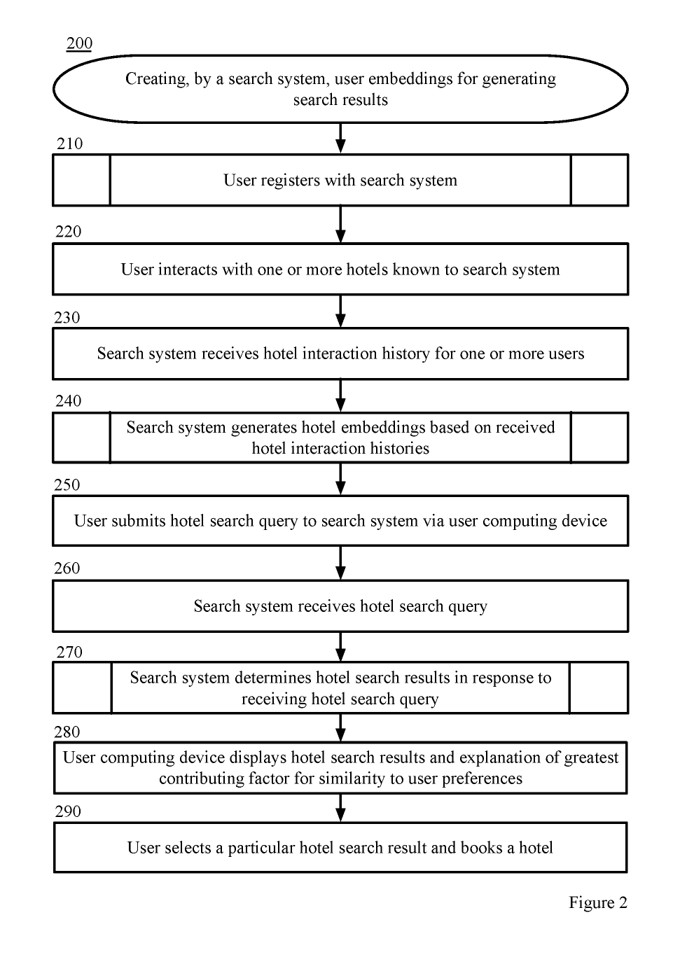

The example methods illustrated in FIGS. 2-3, 5, and 8 are described hereinafter with respect to the components of the example operating environment 100. The example methods of FIGS. 2-3, 5, and 8 may also be performed with other systems and in other environments. The operations described with respect to any of the FIGS. 2-3, 5, and 8 can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

FIG. 2 is a block diagram depicting a method 200 for creating, by a search computing system 130, user specific hotel embeddings for generating hotel search results, in accordance with certain examples. The method 200 is described with reference to the components illustrated in FIG. 1. For example, a search computing system 130 provides an optimized graphical user interface display of item recommendations in response to a particular user's 101 search query by considering an item interaction history for the particular user 101 as well as aggregated item interaction histories for multiple other users 101.

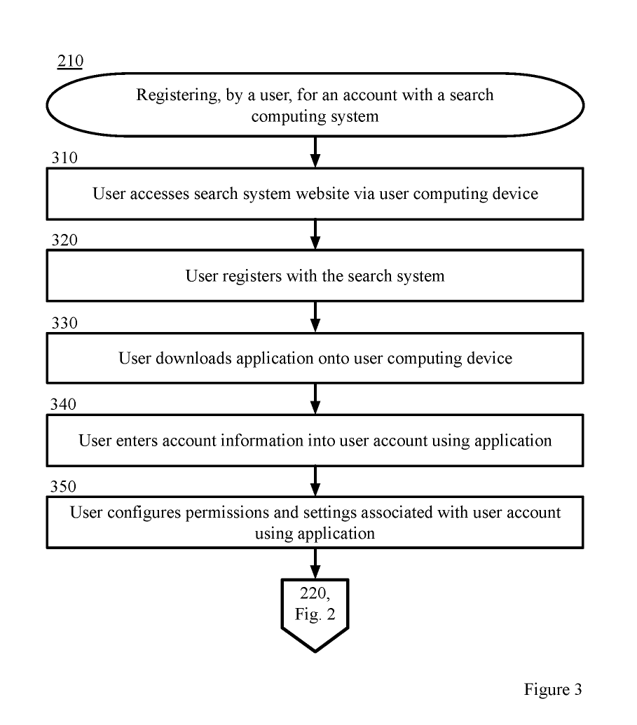

In block 210, the user 101 registers with the search computing system 130. The method 210 for registering, by a user 101, for an account with a search computing system 130 is described in more detail hereinafter with reference to the method described in FIG. 3. In an example, one or more users 101 register for a user 101 account and configure account settings on respective user 101 accounts to permit the search computing system 130 to log user 101 item interaction histories for each of the one or more users 101. For example, each user 101 account logs one or more user 101 interactions. For example, the user 101 account logs a user 101 clicking on an item search result, a user 101 purchasing an item or reserving an item via application 113 or the website 136, or other interactions of the user 101 with one or more items. In an example, the user 101 stores user 101 information and/or one or more search preferences in a user 101 profile on the user 101 account for use in item search queries. By enabling the search computing system 130 to log user 101 interactions via the user 101 account, one or more users 101 enable the search computing system 130 to provide the users 101 with an optimized graphical user interface 111 display of item listings that are relevant based on previous user 101 interactions with item search results. The example method 200 describes a method for registering, by a particular user 101, for an account with the search computing system 130.

FIG. 3 is a block diagram depicting a method 210 for registering, by a user 101, for an account with a search computing system 130, in accordance with certain examples. The method 210 is described with reference to the components illustrated in FIG. 1.

In block 310, the user 101 accesses a search computing system 130 website 136 via the user computing device 110. For example, the user 101 accesses the search computing system 130 website 136 via a web browser 118 of the user computing device 110. In another example, the user 101 otherwise contacts the search computing system 130 to register for a user 101 account.

In block 320, the user 101 registers with the search computing system 130. The user 101 obtains a user 101 account number, receive the appropriate applications and software to install on the user computing device 110 or perform any action provided by the search computing system 130. The user 101 utilizes the functions of the user computing device 110, such as the user interface 111 and the web browser 118, to register and configure a user 101 account. For example, the user 101 accesses a search computing system 130 website 136 via the web browser 118 of the user computing device 110 and selects one or more user interface 111 objects to register for a user 101 account. In an example, user 101 enters contact information of the user 101 and configures one or more user 101 account settings on the user 101 account to permit the search computing system 130 to log a user 101 item interaction history. For example, the user 101 account logs one or more user 101 interactions. For example, the user 101 account logs a user 101 clicking on an item search result, a user 101 purchasing an item or reserving an item via application 113 or the website 136, or other interactions of the user 101 with one or more items. In an example, the user 101 stores user 101 information and/or one or more search preferences in a user 101 profile on the user 101 account for use in item search queries.

In block 330, the user 101 downloads an application 113 onto the user computing device 110. In an example, the application 113 operating on the user computing device 110 is able to communicate with the search computing system 130 over the network 120. For example, when the search computing system 130 user 101 account logs search requests submitted by the user 101, item interactions for search results selected by the user 101 via the user interface 111, user 101 purchases or reservations of items displayed in search results, and/or other interactions of the user 101 with the search computing system 130 website 136 in accordance with one or more user 101 account settings configured by the user 101. In an example, when the user 101 clicks on an item search result via the application 113 or 118, purchases or reserves an item via the application 113 or 118, or otherwise interacts with items and/or item search results, the application 113 logs a time stamp and transmits information concerning the user interaction and the logged timestamp to the search computing system 130 via the network 120. In an example, the application 113 logs and stores one or more user 101 interactions on the user computing device 110 and periodically sends information concerning a batch of logged and stored user 101 interactions to the search computing system 130 via the network 120. In an example, the one or more user 101 interactions comprise interactions with a hotel search website 136, a flight search website 136, and/or one or more interactions with one or more other search computing system 130 websites 136.

In block 340, the user 101 enters payment account information into the user 101 account using the application 113. In an example, the user 101 enters payment account information associated with one or more user 101 accounts, for example, one or more credit accounts, one or more bank accounts, one or more stored value accounts, and/or other appropriate accounts into the user 101 account maintained by the search computing system 130. In an example, the application 113 provides one or more services. For example, the application 113 comprises one or more of a search application, an email application, a scheduling application, a travel and booking application, a mapping application, a recommendation application, a social media application, and other service application. In an example, the user enters preferences for a hotel or travel search, for example, the user's 101 preferred days of the week for travel, preferred dates of travel, general price affinity, home/work zip code, travel preferences (for example, “international” or “backpacking”), a preferred number of travelers, one or more preferred travel locations, one or more preferred hotel merchants, one or more preferred hotel accommodations (for example, “continental breakfast included,” “king size bed,” “kitchen included”), one or more preferred transportation accommodations, and other preferences. By submitting user 101 preferences for hotel or travel searches to store in the user 101 account, the user 101 enables the search computing system 130 to find relevant search results in a search query that satisfy one or more of the user 101 preferences. In an example, the user 101 enters the user 101 preferences using a form provided by the search computing system 130 website 136 via the user interface 111 and application 113 or web browser 118 of the user computing device 110 or otherwise submits the user 101 preferences to the search computing system 130.

In block 350, the user 101 configures permissions and settings associated with the user 101 account using the application 113. For example, the user 101 grants permission for the search computing system 130 to log user 101 interactions with items and/or item search results via one or more the search computing system 130 websites 136. For example, the user 101 grants permission for the search computing system 130 to log user 101 selections of item search results, user 101 purchases or reservations of items, user 101 wish lists comprising one or more desired items, items tagged by the user 101, or other interactions of the user 101 with items and/or item search results. In another example, the user 101 grants permission for the search computing system 130 to receive user computing device 110 location data for use in determining search results responsive to a user 101 search query. In an example, the user 101 configures user 101 account settings or add, delete, or edit payment account information via the application 113. In an example, the user 101 selects an option to enable or disable the permission of the search computing system 130 to process transactions, receive location data of the user computing device 110, or provide other services to the user computing device 110. In an example, the search computing system 130 receives, via the network 120 in accordance with permissions granted by the user 101, the logged user 101 interactions comprising one or more flight reservations, one or more flight searches, one or more hotel reservations, one or more hotel searches, one or more transportation reservations, one or more transportation searches, one or more interactions with products, one or more reviews read or rated, one or more video reviews watched, one or more hotel, flight, or transportation searches on third party websites, hotel stay information obtained from third party websites, and user computing device 110 location history. In an example, the search computing system 130 receives via the network 120 in accordance with permissions granted by the user 101, user computing device 110 data, for example, email data or text message data, comprising one or more hotel reservation confirmations and/or one or more hotel reservation purchases made via the search computing system 130 website 136, a website of a merchant system, a web site of a third party system, or in person at one or more hotels. In an example, the user computing device 110 periodically transmits and/or the search computing system 130 periodically retrieves user computing device 110 data if the user 101 configures permissions and settings associated with the user 101 account to give appropriate permissions to permit the search computing system 130 to log data and/or receive data of the user computing device 110. In an example, the search computing system 130 logs a user 101 interaction history comprising the received one or more user 101 interactions for use in generating optimized graphical user interface displays of items responsive to user 101 item search queries.

From block 350, the method 210 proceeds to block 220 in FIG. 2.

Returning to FIG. 2, in block 220, the user 101 interacts with one or more hotels known to the search computing system 130. For example, the user 101 interacts with hotels known to the search computing system 130 by making hotel reservations, submitting hotel search queries, clicking on one or more hotel search results, interacting with displayed hotel search results via one or more user interface 111 objects, reading hotel reviews, rating hotels, watching video reviews of hotels, and otherwise interacting with one or more hotels known to the search computing system 130 via the user computing device 110 application 113 or 118. In another example, the user computing device 110 device logs location data that corresponds with one or more locations associated with one or more respective hotels known to the search computing system 130 when the user 101 interacts with the one or more respective hotels through visiting the one or more respective hotels carrying the user computing device 110. In another example, the user computing device 110 receives, via the application 113, one or more hotel reservation confirmations or otherwise receives the one or more hotel reservations via the user computing device 110. For example, the user 101 receives one or more emails comprising hotel reservation confirmations and/or hotel purchase confirmations. In this example, the reservations and/or confirmations received on the user computing device 110 for the one or more hotels indicate user 101 interactions with the one or more hotels. In yet another example, the user 101 interacts with one or more hotels by purchasing and/or confirming a hotel reservation using the search computing system 130 website 136, a website of a merchant system, a website of a third party system, or in person at one or more hotels and receives a confirmation of the purchase or reservation interaction on the user computing device 110.

In block 230, the search computing system 130 receives hotel interaction histories for users. In an example, the search computing system 130 logs the hotel interactions for each user that has a user account with the search computing system 130. In an example, logging a hotel interaction for a user comprises logging an identifier identifying a type of hotel interaction, logging a current timestamp indicating a time at which the search computing system 130 logged the hotel interaction, and associating the logged hotel interaction with a user 101 account identifier associated with the user. Example types of hotel interactions comprise reserving a hotel, searching for a hotel, clicking on a particular hotel search result, conducting a payment transaction for a hotel, receiving a confirmation of a hotel reservation or purchase via an email or text message on the user computing device 110, logging location data on the user computing device 110 corresponding to one or more known hotel locations, and other user interactions with hotels known to the search computing system 130. In an example, the search computing system 130 logs one or more hotel interactions of each user in a database in a data storage unit 133 accessible to the search computing system 130. In an example, the search computing system 130 receives, from one or more other search computing systems 130, from one or more merchant computing systems, and/or from one or more computing device associated with the user account, one or more hotel interactions of each user and adds the hotel interactions logged by the respective system and/or computing device to the database.

The search computing system 130 logs, for one or more users 101, one or more hotel interactions comprising hotel reservations. For example, a user 101 accesses, via the application 113 on the user computing device 110, a website 136 of the search computing system 130 that provides hotel search results and actuates one or more objects on the user interface 111 of the user computing device 110 to reserve a particular hotel. In this example, the website 136 transmits a notification to the search computing system 130 that the user 101 reserved the particular hotel and the search computing system 130 receives the notification. In another example, a user 101 reserves a particular hotel on a website and receives a hotel reservation confirmation on the user computing device 110. For example, the user 101 receives an email on an email application 113 of the user computing device 110 with the hotel reservation confirmation or via a text message received on the user computing device 110. In this example, the user 101 has configured account settings 113 to enable the search computing system 130 to parse emails to determine offers and the search computing system 130 parses the email comprising the hotel reservation confirmation to identify the particular hotel and logs the hotel interaction comprising reserving the particular hotel. In other examples, the search computing system 130 receives, from the user computing device 110, user 101 search activity for searches conducted via the application 113 or web browser 118 and parses the received user search activity to identify particular hotels at which the user has reserved a stay. In an example, in response to receiving a notification or otherwise determining that the user 101 reserved the particular hotel, the search computing system 130 logs a current timestamp and logs a hotel interaction for the user 101 comprising the particular hotel identifier corresponding to the hotel confirmation reservation, the user computing device 110 identifier, the current timestamp, and a hotel interaction type indicating a hotel reservation. In an example, the search computing system 130 stores the logged hotel interaction in a database in the data storage unit 133.

The search computing system 130 logs, for one or more users 101, one or more hotel interactions comprising a search for a hotel. For example, a user 101 accesses, via the application 113 on the user computing device 110, a website 136 of the search computing system 130 that provides hotel search results and actuates one or more objects on the user interface 111 of the user computing device 110 to search for a particular hotel or to select a hotel search result comprising a particular hotel from one or more displayed hotel search results. In this example, the website 136 transmits a notification to the search computing system 130 that the user 101 searched for or selected the particular hotel from search results via the user computing device 110 and the search computing system 130 receives the notification. The search computing system 130 logs a current timestamp and logs a hotel interaction for the user 101 comprising the particular hotel identifier, the user computing device 110 identifier, the current timestamp, and a hotel interaction type indicating a search for a hotel. In an example, the search computing system 130 stores the logged hotel interaction in a database in the data storage unit 133.

The search computing system 130 logs, for one or more users 101, one or more hotel interactions comprising clicking on a particular hotel search result. For example, a user 101 views, via the application 113 on the user computing device 110, a display of a search result for a particular hotel communicated by the search computing system 130 to the user computing device 110 via the network 120 and actuates one or more objects on the user interface 111 of the user computing device 110 to select the search result for the particular hotel. In this example, in response to receiving a notification from the user computing device 110 of the selection by the user of the search result, the search computing system 130 logs a current timestamp and logs a hotel interaction for the user 101 comprising the particular hotel identifier, the user computing device 110 identifier, the current timestamp, and a hotel interaction type indicating a selection of a hotel. In another example, a user 101 views, via the application 113 on the user computing device 110, an interface object comprising a link to a website describing a particular hotel and actuates the interface object on the user interface 111 of the user computing device 110 to select the interface object comprising the link for the particular hotel. In another example, the user 101 views, via the application 113 on the user computing device 110, an interface object that, when selected, instructs the application 113 to add the particular hotel to a wish list of the user 101. In this example, the user 101 actuates the interface object to add the particular hotel to the wish list and, in response to receiving a notification from the user computing device 110 of the addition of the particular hotel to the wish list of the user 101, the search computing system 130 logs a current timestamp and logs a hotel interaction for the user 101 comprising the particular hotel identifier, the user computing device 110 identifier, the current timestamp, and a hotel interaction type indicating a search for a hotel. In an example, the search computing system 130 stores the logged hotel interaction in a database in the data storage unit 133.

The search computing system 130 logs, for one or more users 101, one or more hotel interactions comprising conducting a payment transaction for a hotel. For example, a user 101 views, via the application 113 on the user computing device 110, a display of a search result for a particular hotel communicated by the search computing system 130 to the user computing device 110 via the network 120 and actuates one or more objects on the user interface 111 of the user computing device 110 to select the search result for the particular hotel and to initiate a payment transaction via the user 101 account to reserve the particular hotel. For example, the search computing system 130 comprises a payment processing system or otherwise communicates with a payment processing system that processes the payment transaction. In this example, in response to receiving a notification from the payment processing system of the payment transaction associated with the user 101 account, the search computing system 130 logs a current timestamp and logs a hotel interaction for the user 101 comprising the particular hotel identifier, the user computing device 110 identifier, the current timestamp, and a hotel interaction type indicating a purchase of a hotel reservation. In another example, a user 101 purchases a hotel reservation for a particular hotel on a website and receives a receipt for a purchase transaction on the user computing device 110. For example, the user 101 receives an email on an email application 113 of the user computing device 110 with the confirmation of the purchase of the hotel reservation for the particular hotel. In this example, the user 101 has configured account settings 113 to enable the search computing system 130 to parse emails to determine offers and the search computing system 130 parses the email comprising the confirmation of the purchase of the hotel reservation for the particular hotel to identify the particular hotel and logs the hotel interaction comprising purchasing a reservation for the particular hotel. In an example, in response to determining the purchase of the particular hotel reservation, the search computing system 130 logs a current timestamp and logs a hotel interaction for the user 101 comprising the particular hotel identifier corresponding to the hotel confirmation reservation, the user computing device 110 identifier, the current timestamp, and a hotel interaction type indicating a purchase of a hotel reservation. In an example, the search computing system 130 stores the logged hotel interaction in a database in the data storage unit 133.

The search computing system 130 logs, for one or more users 101, one or more hotel interactions comprising physical visits by users 101 to one or more locations associated by the search computing system 130 with respective hotels. In an example, a user 101 visits locations associated with hotels and the user computing device 110 device logs location data indicating that the user computing device 110 was located at those locations. In an example, the search computing system 130 periodically receives location data from the user computing device 110 and reviews the received location data to determine if the user computing device 110 was previously located at one or more hotels known to the search computing system 130. For example, the search computing system 130 comprises a database comprising one or more hotels and associated location data. The search computing system 130 accesses the data base and compares the received location data against the location data in the database to determine whether the user 101 visited any of the hotels in the database. In an example, in response to determining that the location data comprises a location corresponding to a location associated with a hotel, the search computing system 130 logs the timestamp associated with the location data and logs a hotel interaction for the user 101 comprising the particular hotel identifier corresponding to the hotel confirmation reservation, the user computing device 110 identifier, the current timestamp, and a hotel interaction type indicating a physical stay at the hotel. In certain examples, the search computing system 130 stores received and/or logged hotel interaction histories for one or more users 101 in the form of user-hotel matrices representing a relation between users 101 and particular hotels, or between particular hotels and other particular hotels. In an example, the search computing system 130 stores the created user-hotel matrices in the data storage unit 133. An example user-hotel matrix comprises rows representing users 101, columns representing hotel identifiers, and values represent the number of interactions with that hotel (or a value derived from this quantity) of a particular type by a particular user. In an example, the search computing system 130 stores the logged hotel interaction histories in a database in the data storage unit 133.

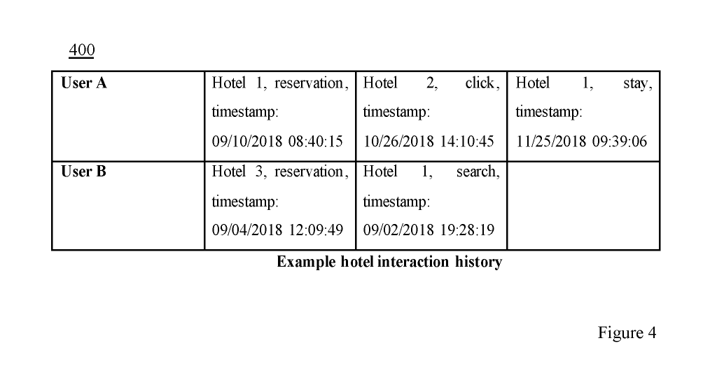

FIG. 4 is an example illustration of logged hotel interaction histories 400 for multiple users, in accordance with certain examples. In an example, the search computing system 130 determines that user A reserved hotel 1, clicked on hotel 2, and stayed at hotel 1, and user B reserved hotel 3 and searched for hotel 1 and the search computing system 130 logs these hotel interactions for users A and B in the database. In this example illustrated in the logged hotel interaction histories 400, the search computing system 130 logs hotel interactions for user A and user B in hotel interaction histories comprising, for each hotel interaction, an indication of the particular hotel associated with the hotel interaction, the type of interaction, and a timestamp associated with a time at which the search computing system 130 logs the hotel interactions. For example, the type of interaction is indicated in the logged hotel interaction histories 400 via type identifiers reading “reservation,” “click,” “stay,” and “search.”

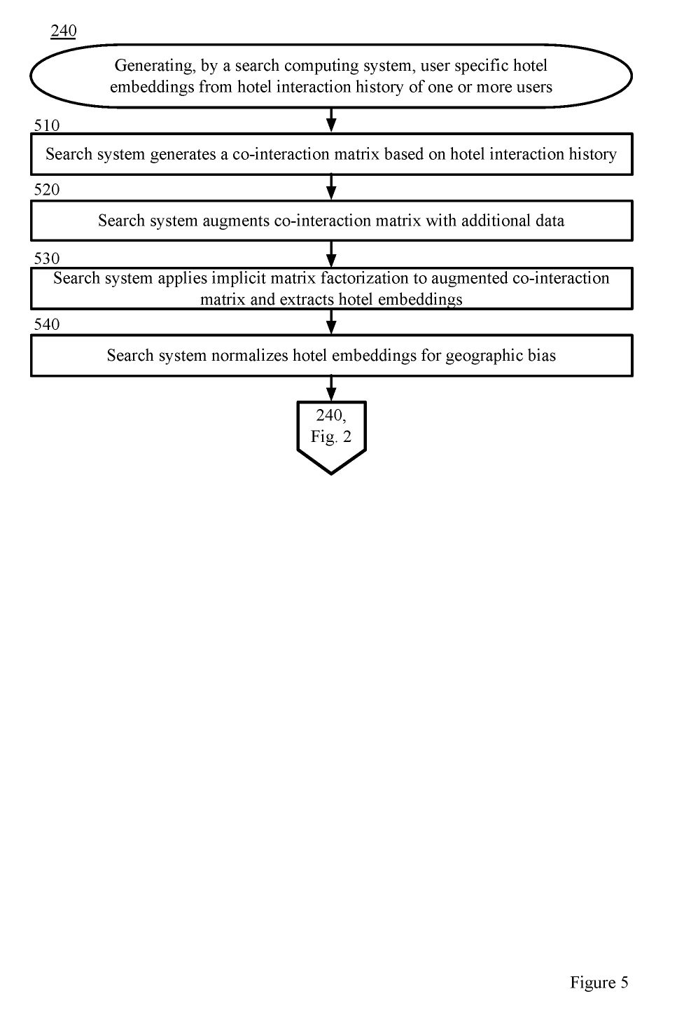

Returning to FIG. 2, in block 240, the search computing system 130 generates hotel embeddings based on received hotel interaction histories. The method for generating, by a search computing system 130, user specific hotel embeddings from a hotel interaction history of one or more users 101 is described in more detail hereinafter with reference to the method described in FIG. 5.

FIG. 5 is a block diagram depicting a method 240 for generating, by a search computing system 130, hotel embeddings from a hotel interaction history of one or more users 101, in accordance with certain examples. The method 240 is described with reference to the components illustrated in FIG. 1. The example method 240 described in FIG. 5 is also applicable to determining flight embeddings for use in flight search queries, product embeddings for use in shopping queries, and ticketing embeddings for use in ticketing and event queries, or determining item embeddings for use in other types of user 101 search queries. In an example, the search computing system 130 periodically generates hotel embeddings according to example method 240. For example, the search computing system generates new hotel embeddings each day, once a week, every two weeks, every month, or at other appropriate intervals as configured by a search computing system 130 operator. In an example, the search computing system 130 compares generated hotel embeddings against individual user 101 embeddings to generate similarity scores for hotel search results and optimize displays of search results including the hotel search results ranked according to similarity score.

In block 510, the search computing system 130 generates a co-interaction matrix based on the received hotel interaction history. In an example, generates the co-interaction matrix based on information in the received and/or logged hotel interaction histories for one or more users 101. In an example, the search computing system 130 generates a co-interaction matrix where the rows represent hotel identifiers associated with each of all hotels known to the search computing system 130 and the columns also represent the hotel identifiers for each of all hotels known to the search computing system. The search computing system 130 inserts a value at each intersection of hotel identifiers in the co-interaction matrix to indicate a number of common users for which the search computing system 130 logged a particular type of hotel interaction with both of the hotels associated with the corresponding two hotel identifiers in the logged hotel interaction histories (or a value derived from this quantity). In an example, the co-interaction matrix comprises a representation of hotels as a vector of floating point numbers called embeddings. In an example, the search computing system 130 knows of 100 particular hotels and generates a co-interaction matrix comprising a co-reservation matrix for the 100 hotels based on the received hotel interaction histories for one or more users 101.

In certain examples, the search computing system 130 generates multiple co-interaction matrices based on multiple types of data from received and/or logged hotel interaction histories for one or more users 101. For example, the search computing system 130 generates a co-interaction matrix based on data from the hotel interaction histories that is specific to the interaction of reserving hotels. In another example, the search computing system 130 generates a co-click matrix including values corresponding to numbers of common users who clicked both of any two hotels. In another example, the search computing system 130 generates a co-review matrix including values corresponding to numbers of common users who reviewed both of any two hotels. In another example, the search computing system 130 generates a co-stay matrix showing values corresponding to numbers of common users associated with user computing device 110 location data indicating that the common users stayed at both of any two hotels. In an example, the search computing system 140 stores the generated co-interaction matrix in the data storage unit 133.

FIG. 6 is an example illustration of a co-interaction matrix 600, in accordance with certain examples. As illustrated in co-interaction matrix 600, for a total number of H hotels, the search computing system 130 generates a co-interaction matrix having a size of H×H (the number of both rows and columns being equal to H) for hotel interactions comprising reservations. Accordingly, as illustrated in co-interaction matrix 600, the search computing system 130 generates a co-interaction matrix having 100 rows and 100 columns. In this example, as illustrated in co-interaction matrix 600, the search computing system 130 determines, based on received and/or logged hotel interaction histories, that 11 users 101 reserved both hotel 2 and hotel 1 and indicates the 11 users as a value of 11 at the two intersections of hotel 1 and hotel 2 in the co-interaction matrix 600.

Returning to FIG. 5, in block 520, the search computing system 130 augments the co-interaction matrix with additional data. In certain examples, since users' 101 choice of hotel is limited by external factors (such as travel destinations and budgets), an example co-interaction matrix is extremely sparse. For example, 99% of the values in an example co-interaction matrix are zero. In an example, the search computing system 130 augments the co-interaction matrix with additional hotel interactions of a type other than the type of interaction used to generate the co-interaction matrix. For example, the co-interaction matrix represents users 101 who reserved hotels and the search computing system 130 augments the co-interaction matrix with other types of hotel interactions other than hotel reservations, including one or more of hotel searches, hotel impressions, clicks on hotel results, conversions, and hotel reviews entered. In an example, these additional hotel interactions are given less weight than the principal type of hotel interaction used to initially generate the original co-interaction matrix.

In another example, the search computing system 130 augments the co-interaction matrix with hotel metadata such as a star rating, price information, a hotel chain identifier, and a category of hotel. For example, a hotel category comprises “luxury,” “budget,” or “bed and breakfast.” In this other example, each such field of augmented data is added as an additional column and row in the co-interaction matrix. For example, a column “category=luxury” would have the value 1 if a particular hotel in that row is known to be a luxury hotel. In yet another example, the search computing system 130 augments the co-interaction matrix with other online activities, for example, flight reservations, flight searches, interactions with products, reviews read or rated, video reviews watched, and hotel/flight searches on third party web sites. In yet another example, the search computing system 130 augments the co-interaction matrix with other online activities, for example, flight reservations, flight searches, interactions with products, reviews read or rated, video reviews watched, hotel/flight searches on third party websites, hotel stay information obtained from third party websites, hotel stays determined using user computing device 110 location history. In yet another example, the search computing system 130 augments the co-interaction matrix with user's 101 non-hotel-related preferences, such as general price affinity, home/work zip code, travel preferences (for example, “international” or “backpacking”), and a number of travelers. This method of data augmentation is particularly helpful to bias hotels with less bookings to be similar to hotels that share the same characteristics. In certain examples, the search computing system 130 does not augment the co-interaction matrix with additional data.

In block 530, the search computing system 130 applies matrix factorization to the augmented co-interaction matrix and extracts hotel embeddings. For example, the search computing system applies matrix factorization to generalize data contained in the augmented co-interaction matrix. In an example, for a number of factors F, the search computing system 130 generates two factor matrices of size H×F and F×H, respectively. Columns from the second matrix, herein called hotel embeddings, are extracted. Hotel embeddings are dense vectors of floating point numbers that capture higher-level patterns in users' 101 hotel interaction history. In an example, the search computing system 130 factorizes a binary version of the co-interaction matrix by replacing all non-zero values by one and uses the values in the factorized co-interaction matrix as weights to give less importance to potentially noisy signals. In another example, the search computing system 130 applies other parametrizations of matrix factorization to the co-interaction matrix such as using the values directly or calculating the pointwise mutual information for co-interactions.

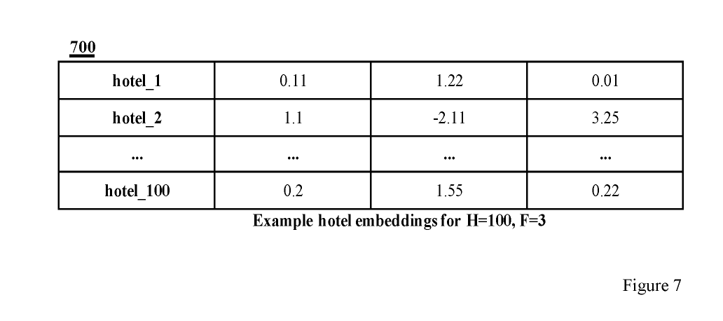

FIG. 7 is an example illustration of a hotel embeddings matrix 700, in accordance with certain examples. As illustrated in the hotel embeddings matrix 700, the search computing system 130, by generating hotel embeddings, extracts each hotel's latent characteristics in a low-dimensional space. In examples, particular hotels that have similar metadata, or user 101 interaction and online activity patterns associated with them, are expected to have common intrinsic characteristics (such as pricing, location, architecture or other finer-grained attributes), and the search computing system 130 generates hotel embeddings for these particular hotels that are closer to each other, which enables use of a distance metric (such as cosine distance) between two hotel embeddings as a basis of hotel comparison.

Returning to FIG. 5, in block 540, the search computing system 130 normalizes hotel embeddings for geographic bias. For example, a challenge of hotel recommendation is that the choice of hotel is highly restricted by users' destination. This restriction means that, in hotel embeddings, there is more overlap in regions between which users travel frequently (e.g., inside a same country) than between regions where there are less travelers in common. The direct repercussion of this skew is that the geographical constraint is represented in the hotel embeddings described above, resulting in hotel embeddings from a particular region being closer to each other than hotel embeddings from multiple regions. To normalize to correct for geographic bias in hotel embeddings, the search computing system 130 groups hotel embeddings from a same region (at the city level, or via geographic clustering), and—for each group of hotels—calculates the average embedding for the respective group of hotels and subtracts the average hotel embedding from each of the respective group of hotels. The search computing system 130, by normalizing hotel embeddings to correct for geographic bias, removes the contribution of a hotel's location to its embedding, only representing truly separates it from other hotels in its hotel embedding value in the hotel embeddings matrix. This example process of normalizing hotel embedding is particularly useful when performing hotel clustering in response to search queries because it removes geographic location as a consideration when organizing hotel embeddings, which may not be helpful or relevant to a searching user.

From block 540, the method 240 proceeds to block 250 in FIG. 2.

Returning to FIG. 2, in block 250, the user 101 submits a hotel search query to the search computing system 130 via the user computing device 110. For example, the user 101 selects the application 113 and inputs, via the application 113 and the user interface 111, a hotel search query to the website 136 of the search computing system 130 comprising one or more search terms. In another example, the user 101 inputs the hotel search query via a web browser 118 to the website 136 of the search computing system 130. For example, the user 101 inputs a hotel search query comprising “hotel for 3-night stay in Ft. Lauderdale, Fla.” In an example, the user 101 inputs one or more parameters in a free form text search query to the website 136, for example, “hotels in Atlanta, Ga. Feb. 4-6, 2019.” In another example, the user 101 inputs the search query to the website 136 in a search form. In an example, the user 101 actuates one or more user interface 111 objects to submit the search query to the search computing system 130 via the network 120. For example, the user 101 selects a user interface 111 object that reads “search.” For example, the user 101 actuates one or more user interface 111 objects of the user computing device 110 to select a check-in date, a checkout date, a city, a state, a country, a bed type preference, a number of guests, a number of rooms, and one or more other preferences.

In block 260, the search computing system 130 receives the hotel search query. For example, the search computing system 130 receives the hotel search query via the network 120 from the user computing device 110. The search computing system 130 receives user computing device 110 data, for example, user 101 account data stored on the user computing device 110 and location data logged by the user computing device 110, along with the hotel search query. For example, the search computing system 130 determines a user's 101 desired location for a hotel search based on user computing device 110 location data. For example, the user 101 is currently in an area in which the user 101 is searching for hotels and submits a query for “hotels near me” and the search computing system 130 determines hotel search results based on the location data received from the user computing device 110. In another example, the search computing system 130 determines one or more parameters of the search query based on user 101 account preferences stored on the user computing device 110 or stored on the search computing system 130. For example, the user 101 prefers hotel rooms with one king sized bed and continental breakfast included and the search computing system 130 searches for hotel search results satisfying the user's preferences.

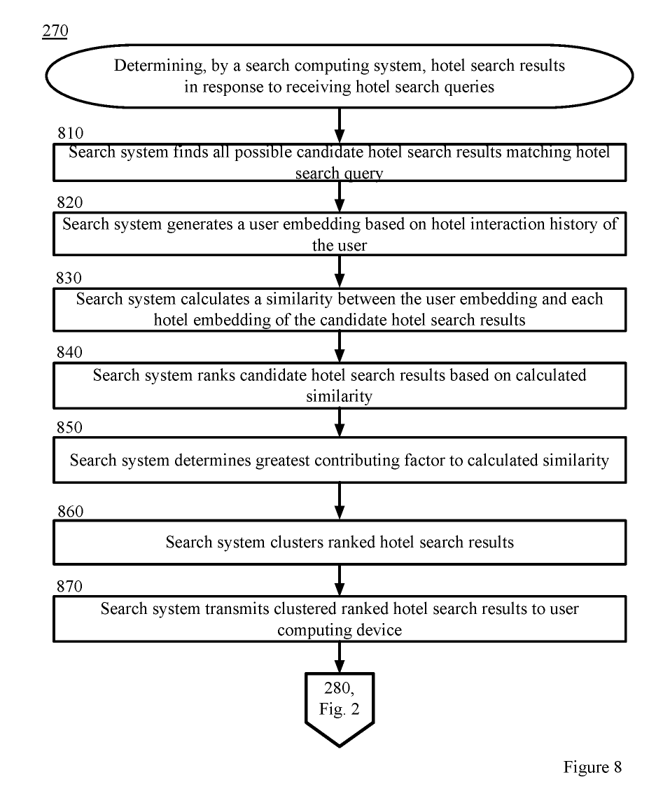

In block 270, the search computing system 130 determines hotel search results in response to receiving the hotel search query. Methods for determining hotel search results in response to receiving hotel search queries are described in more detail hereinafter with reference to the method described in FIG. 8. The example methods described in blocks 250, 260, 270, and FIG. 8 apply to determining search results for a hotel search query but also applies to determining search results for queries for other items, for example, flight search queries, shopping queries, and ticketing and event queries using user 101 specific embeddings.

FIG. 8 is a block diagram depicting a method 270 for determining, by a search computing system 130, hotel search results in response to receiving hotel search queries, in accordance with certain examples. The method 270 is described with reference to the components illustrated in FIG. 1.

In block 810, the search computing system 130 finds all possible candidate hotel search results matching the hotel search query. In an example, when the search system 130 receives a hotel search query (i.e., “Hotels in New York” or “Hotels near the Eiffel Tower”), the search computing system 130 analyzes and/or parsers the hotel search query to find all possible candidate hotels matching the hotel search query. The search computing system 130 retrieves the initial hotel search results or the search computing system 130 requests hotel search results from another system via the network 120 and receives the hotel search results from the other system via the network 120.

In block 820, the search computing system generates a user 101 embedding based on the hotel interaction history for the user 101. In an example, the search computing system 130 periodically and/or continuously logs and/or receives hotel interaction histories for one or more users 101 In this example, the search computing system 130 extracts the hotel interaction history of the user 101 that submitted the search query. In an example, the search computing system 130 determines, for the user 101, a user 101 embedding comprising an average hotel embedding for the user 101 based on all the hotel embeddings for hotels which the user 101 reserved, stayed at, searched, clicked, or otherwise interacted. For example, the search computing system 130 retrieves the generated hotel embeddings matrix, extracts hotel embeddings for hotels which the user 101 reserved, stayed at, searched, clicked, or otherwise interacted, and determines the average hotel embedding of the extracted hotel embeddings. In another example, the search computing system 130 determines a user 101 embedding comprising a weighted average hotel embedding for the user 101 based on all the hotel embeddings for hotels which the user 101 reserved, stayed at, searched, clicked, or otherwise interacted, giving a greater weight to hotel embeddings that are more recent and a lesser weight to hotel embeddings that are further back in time in calculating the weighted average hotel embedding. For example, the search computing system 130 retrieves the generated hotel embeddings matrix, extracts hotel embeddings for hotels which the user 101 reserved, stayed at, searched, clicked, or otherwise interacted, and determines the average hotel embedding of the extracted hotel embeddings according to a weighted average algorithm. In some examples, the search computing system 130 uses a median, a mode, or other measure instead of an average or weighted average. In an example, the search computing system 130 stores the determined user 101 embedding for use in determining results for later hotel search queries. In another example, the search computing system 130 does not store the determined user 101 embedding.

In block 830, the search computing system 130 calculates a similarity between the user 101 specific hotel embedding and each hotel embedding of the candidate hotel search results. For example, the search computing system 130 generates, in response to receiving the search query, the user 101 embedding based on the hotel interaction history for the user 101. In another example, the search computing system 130 identifies a user 101 account associated with the searching user 101 based on a user computing device 110 identifier received in the hotel search query and retrieves a previously generated user 101 specific hotel embedding corresponding to the user 101 account. In another example, the search computing system 130 determines a user 101 specific hotel embedding for the searching user 101 as described herein in response to receiving the hotel search query via the network 120. In an example, the search computing system calculates a cosine similarity between the user 101 specific hotel embedding and each of hotel embeddings associated with the initially retrieved hotel search results, and uses this similarity to rank hotels according to how well they match the user's 101 specific hotel embedding.

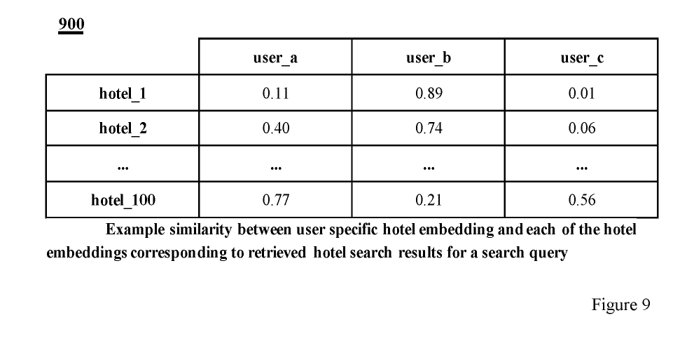

FIG. 9 is an example illustration of similarity matrices 900, in accordance with certain examples. As illustrated in the similarity matrices 900, the search computing system 130 calculates a similarity between user 101 specific hotel embeddings and each of the hotel embeddings corresponding to respective retrieved hotel search results an generates similarity matrices for each user 101. For example, the similarity matrices 900 illustrates three example similarity matrices generated for search queries submitted separately by separate users a, b, and c. The similarity matrices 900 illustrate that for different users, the calculated similarity values for the same retrieved search results will vary according to differences in each users' 101 user-specific hotel embedding. In certain examples, the similarity scores generated by the search computing system 130 described above are used directly or combined or mixed with the scores generated by other scoring systems to express the quality of each candidate hotel search result as applied to a particular user 101. By combining or mixing the similarity scores determined by the search computing system 130 with scores determined by other scoring systems, the search computing system 130 controls the impact of personalization on the ranking independently from other factors.

Returning to FIG. 8, in block 840, the search computing system 130 ranks candidate hotel search results based on the calculated similarity. In an example, the search computing system 130 ranks the candidate hotel search results in ascending or descending order according to the calculated similarity score from comparing the hotel embedding of each candidate hotel search result to the user specific hotel embedding.

In block 850, the search computing system 130 determines a greatest contributing factor to the calculated similarity. For example, the search computing system 130 normalizes the distance metric used to determine the calculated similarity to account for various biases (hotels in similar locations having higher similarity scores), and provide a calibrated similarity measure. The search computing system 130 system calculates a contribution of a user's 101 input signal to their user embedding and the final calculated similarity score, and determines the most impactful signals to explain the recommendations. In an example, the search computing system 130 infers outstanding preferences from user 101 signals (e.g., online activity, hotel interaction history signals that are significantly more present in the user's 101 online activity than in the general user 101 population) and matches the user 101 signals with each candidate hotel search result to interpret their contribution to the calculated similarity. For example, to calculate contributing factors, the search computing system 130 normalizes a distance metric used to calculate the similarity scores between the user 101 embedding and each of the candidate hotel search results to account for various biases (hotels in similar locations having higher similarity scores), and to provide a calibrated similarity measure. For example, the search system 130 calculates the contribution of a user's 101 input signal to their user 101 specific embedding, and the final similarity score, and determines the most impactful signals to explain each of the hotel search results. The search computing system 130 infers outstanding preferences from user signals (e.g., signals that are significantly more present in the user's online activity than in the general user population) and match them with each recommendation to interpret one or more of the user's 101 hotel search results. An example signal comprises the user 101 submitting a hotel review, the user 101 clicking on a hotel search result, the user 101 staying at a hotel as indicated by user computing device 110 location data, the user 101 reserving a hotel, the user 101 purchasing a hotel, or other user 101 signals with respect to hotels associated with user specific hotel embeddings that the search computing system 130 determines from the user's 101 item interaction history. In an example, the search computing system 130 determines a greatest contributing factor from among the determined contributing factors providing the greatest calculated contribution of the user's 101 input signal to the user 101 specific hotel embedding. Indicating the greatest contributing factor to a user 101 may assist the user 101 in confirming a decision to reserve a hotel associated with a hotel result and also provides the user 101 with an explanation for why the search result appears in a prominent position in an optimized display of hotel search results.

In block 860, the search computing system 130 hierarchically clusters the ranked hotel search results. In an example, the search computing system 130 uses a hierarchical clustering algorithm on the hotel embeddings of the candidate hotel search results to create a taxonomy of hotel sets in an unsupervised manner, without requiring human intervention. Example clusters comprise groups of hotel search results that are similar to each other (with respect to a configurable similarity metric, for example, cosine similarity), and different enough from other hotels. In this example, similarity and difference is based on the determined hotel embeddings or based on other scoring systems. An example hotel set comprises: “Boutique Hotels” or “Bed And Breakfast Hotels.” The search computing system 130 identifies labels for these clusters by finding a higher representation of a certain metadata field (for example, the previously described fields: star rating, category label, pricing) or based on a textual analysis of user reviews to find terms that are over-represented among the cluster. The search computing system 130 identifies hotels as being similar without knowing particular characteristics of each hotel, based on the overlapping co-interaction information, as described herein. In an example, the search computing system 130 generates these hotel sets using the hotel embeddings generated as described previously and not by directly matching a limited number of metadata fields (for example, grouping all hotels that have the category “boutique.” Accordingly, this method of generating, by the search computing system 130, hierarchically clustered and ranked hotel search results is robust to missing or noisy metadata.

In block 870, the search computing system 130 transmits the clustered ranked hotel search results to the user computing device 110. For example, the search computing system 130 transmits, via the network 120, the hierarchically clustered and ranked hotel search results to the user computing device 110 via the network 120. In an example, the user computing device 110 receives the hierarchically clustered and ranked hotel search results from the search computing system 130 via the network 120. In an example, each of the hierarchically clustered ranked hotel search results includes the calculated contribution of one or more of the user's 101 input signals to their user embedding and to the final calculated similarity score.

From block 870, the method 270 proceeds to block 280 in FIG. 2.

Returning to FIG. 2, in block 280, the user computing device 110 renders optimized displays of hotel search results and an explanation of the greatest contributing factor for similarity to user 101 preferences. For example, the search computing system provides an optimized display of item search results to the user computing device 110 for display by the user computing device 110 that emphasizes hotel search results that are relevant to the user based on the determined similarity values describing a similarity between the user 101 specific hotel embedding and each hotel embedding of the candidate hotel search results. For example, relevant hotel search results comprise search results corresponding to similarity values of candidate search results that are above a predefined threshold similarity value, similarity values of a group of candidate search results of a predefined number having the highest similarity values of all of the candidate search results, similarity values of candidate search results having attributes corresponding to one or more user preferences that also exceed a predefined threshold similarity value, or other measures of relevance to the user. In an example, the most relevant hotel search results are emphasized by being placed in a first or top-most location in a listing of hotel search results. In an example, the most relevant hotel search results are annotated in the listing of search results with text and/or user interface objects indicating to the user that the hotel search result is relevant. For example, one or more hotel search results comprise text annotation reading “best result” or comprise a user interface object comprising a star next to the search result.

In certain examples, the optimized display of search results comprises one more interface objects selectable by a user via the user computing device 110. In certain examples, similar hotels are displayed as recommendations when the user searches for a specific hotel or clicks on a specific hotel from a list of the displayed hotel search results. The system provides a user with a user interface 111 display that explains why the user 101 is receiving each particular hotel search result. An example user interface 111 display comprises a first result and an explanation that reads “This hotel is a X % match.” For example, a distance metric used to calculate the similarity between user 101 specific hotel embedding and each of the hotel embeddings associated with hotel search results can be displayed to the user 101 via the user interface 111. For example, for a cosine similarity of 0.95, the search computing system 130 might conclude that a hotel embedding for a particular hotel search result is a 95% match to the user's 101 specific hotel embedding.

In another example, the search computing system 130 normalizes the distance metric used to calculate the similarity scores between the user 101 embedding and each of the candidate hotel search results to account for various biases (hotels in similar locations having higher similarity scores), and provide a calibrated similarity measure. The search system 130 calculates the contribution of a user's 101 input signal to their user 101 specific embedding, and the final similarity score, and surfaces the most impactful signals to explain each of the hotel search results. The search computing system 130 infers outstanding preferences from user signals (e.g., signals that are significantly more present in the user's online activity than in the general user population) and match them with each recommendation to interpret one or more of the user's 101 hotel search results. An example user interface 111 display comprises a first result and an explanation that reads “Because you stayed at hotel X” or “Because you searched for hotel X,” “Because you like hotels with pools and free wifi,” indicating a largest contributing factor to the determined similarity score for each hotel search result. In an example, the listing of hotel search results comprises a display of a hotel search result along an explanation that reads “This search result is a X % match,” wherein the value for X is determined based on a similarity value for the candidate hotel search result corresponding to the displayed hotel search result. In another example, one or more hotel search results are emphasized with an explanation as to why the respective hotel search result appears in the optimized listing of hotel search results. An example user interface 111 display comprises a first hotel search result and an explanation that reads “Because you purchased/reserved this hotel previously” or “Because you searched for this hotel previously,” “Because you have preference A and preference B,” indicating a largest contributing factor to the appearance of the hotel search result in the listing of search results.

In block 290, the user 101 selects a particular hotel search result and books a hotel. In an example, the user 101 actuates one or more user interface 111 objects to review one or more search results displayed via the user interface 111. For example, the user 101 scrolls through, swipe through, or provide another appropriate input to the user interface 111 to review search results via the user interface 111. In an example, the user 101 actuates one or more user interface 111 objects to select a particular hotel search result and select an option to reserve the hotel. In an example, the user 101 further actuates one or more user interface 111 objects to select particular dates of stay for the hotel reservation, a particular number of guests for the dates of stay, and other appropriate inputs needed to make a hotel reservation. In response to the one or more user 101 inputs, the user computing device 110 transmits, via the network 120, a request to reserve the selected hotel. In an example, the search computing system 130 receives the request to reserve the hotel, reserves the hotel for the user for the indicated dates of stay, and transmits, via the network 120, receipt data to the user computing device 110 for display via the user computing device 110. In an example, the user computing device 110 receives the receipt data and displays, via the user interface 111 the receipt data to the user 101. In another example, the search computing system 130 receives, from the user computing device 110, a selection of a particular item search result from the optimized display of search results and transmits further information to the user computing device 110 concerning the selected item search result in response to receiving the selection.

Certain examples described herein refer to generating optimized displays of hotel search results, however, the methods to generate an optimized display of hotel search results may be applied to generating optimized displays of flight search results, rental property search results, transportation search results, flight search results, vacation bundle search results, ticket and event sales search results, shopping search results, or other types of search results. For example, a search computing system receives a shopping interaction history for each of one or more user accounts associated with one or more respective users describing one or more interactions of each of the one or more users with shopping search results, purchases of items in shopping search results and generates a co-interaction matrix based on the received shopping interaction history. The search computing system generates an embeddings matrix comprising a shopping item embedding for each of one or more shopping items and extracts a shopping item embedding from the embeddings matrix for each of the one or more shopping items. The search computing system receives, from a user computing device associated with the particular user, a shopping search query comprising one or more search parameters. The search computing system retrieves the shopping interaction history associated with the particular user and generates, for the particular user, a user embedding based on the shopping interaction history associated with the particular user. The search computing system identifies shopping item search results that are responsive to the shopping search query, retrieves the item embedding for each of the one or more shopping item search results, and determines, for each of the one or more item search results, a similarity value corresponding to a similarity between the corresponding item embedding and the user specific embedding for the particular user. The search computing system ranks the one or more shopping item search results based on the determined similarity values and transmits, to the user computing device associated with the particular user, the one or more ranked item search results and instructions for the user computing device to display the one or more ranked item search result in an optimized display of shopping search results.

### Other Examples

FIG. 10 depicts a computing machine 2000 and a module 2050 in accordance with certain examples. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain examples, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The examples described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different examples, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the examples, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to optimize item display on graphical user interfaces, comprising:
receiving, by one or more computing devices, a request to render a listing of item entries on a user interface of a user computing device;
analyzing, by the one or more computing devices, first item type interaction histories to determine item embedding values by:
receiving the first item type interaction histories for each of two or more users, the first item type interaction histories describing one or more interactions of a first kind by each of the two or more users with one or more items of a first item type;
generating a co-interaction matrix comprising rows and columns corresponding to each of the one or more items and matrix element values each representing a number of users determined to have the first kind of interaction with a row item of the corresponding row and a column item of the corresponding column within the co-interaction matrix;
generating an embeddings matrix comprising an item embedding value for each of the one or more items; and
extracting the item embedding value for each of the one or more items from the embeddings matrix;
analyzing, by the one or more computing devices, the first item type interaction histories to generate a user embedding value based on the first item type interaction history for a user associated with the user computing device;
generating, by the one or more computing devices, the listing of item entries on the user interface of the user computing device by:
identifying each of the item entries that are responsive to the request to render the listing of item entries, the item entries comprising one or more corresponding items;
retrieving the item embedding value for each of the one or more item results;
determining similarity values corresponding to a similarity between the determined item embedding value for each of the one or more items and the generated user embedding value; and
ranking the one or more item results based on the determined similarity values, the ranking of the one or more item results comprising a preferred first item in a first position; and
rendering, by the one or more computing devices, an optimized display of the one or more item results on the user interface of the user computing device, the optimized display comprising the preferred first item in the first position with each remaining item of the ranked one or more item results in a corresponding ranked non-first position.

2. The method of claim 1, further comprising:
receiving, by the one or more computing devices, additional data comprising one or more interactions of a second kind by each of the two or more users with the one or more items of the first item type;
augmenting, by the one or more computing devices, the co-interaction matrix with additional rows and columns corresponding to the additional data.

3. The method of claim 1, further comprising:
identifying, by the one or more computing devices from the determined item embedding values, one or more geographically proximate item embedding values, the geographically proximate item embedding values comprising locations that are within a threshold distance from each other;
determining, by the one or more computing devices, an average item embedding value for the identified one or more geographically proximate item embeddings; and
modifying, by the one or more computing device, each of the determined item embedding values based on the determined average item embedding value to generate a modified item embedding value for each of the one or more geographically proximate item embedding values.

4. The method of claim 1, further comprising:
determining, by the one or more computing devices for each of the determined item embedding values, a cosine distance between the respective item embedding value and each of the other extracted item embedding values; and
clustering, by the one or more computing devices, the determined item embedding values into a hierarchy based on the determined cosine distances using a clustering algorithm.

5. The method of claim 1, further comprising:
determining, by the one or more computing devices for each of the determined similarity values for the user associated with the user computing device, a greatest contributing factor to the determined similarity value based on the first item type interaction history for the user associated with the user computing device,
wherein rendering the optimized display the one or more item search results comprises displaying the corresponding greatest contributing factor for each of the one or more item search results.

6. The method of claim 1, wherein the interaction of the first kind comprises completing a required number of interactive steps with a selected item and wherein the interaction of the second kind comprises one or more of a making a selection, submitting a review, and submitting a service request.

7. The method of claim 1, wherein the first item type comprises a particular type of service and wherein the one or more items comprise venues offering the particular type of service.

8. A computer program product, comprising:
a non-transitory computer-readable medium having computer-executable program instructions embodied thereon that when executed by computer cause the computer to generate user specific search results to display via graphical user interfaces, the computer-executable program instructions comprising:
computer-executable program instructions to receive a request to render a listing of item entries on a user interface of a user computing device;
computer-executable program instructions to analyze first item type interaction histories to determine item embedding values by:
receiving the first item type interaction histories for each of two or more users, the first item type interaction histories describing one or more interactions of a first kind by each of the two or more users with one or more items of a first item type;
generating a co-interaction matrix comprising rows and columns corresponding to each of the one or more items and matrix element values each representing a number of users determined to have the first kind of interaction with a row item of the corresponding row and a column item of the corresponding column within the co-interaction matrix;
generating an embeddings matrix comprising an item embedding value for each of the one or more items; and
extracting the item embedding value for each of the one or more items from the embeddings matrix;
computer-executable program instructions to analyze the first item type interaction histories to generate a user embedding value based on the first item type interaction history for a user associated with the user computing device;
computer-executable program instructions to generate the listing of item entries on the user interface of the user computing device by:
identifying each of the item entries that are responsive to the request to render the listing of item entries, the item entries comprising one or more corresponding items;
retrieving the item embedding value for each of the one or more item results;
determining similarity values corresponding to a similarity between the determined item embedding value for each of the one or more items and the generated user embedding value; and
ranking the one or more item results based on the determined similarity values, the ranking of the one or more item results comprising a preferred first item in a first position; and
computer-executable program instructions to render an optimized display of the one or more item results on the user interface of the user computing device, the optimized display comprising the preferred first item in the first position with each remaining item of the ranked one or more item results in a corresponding ranked non-first position.

9. The computer program product of claim 8, further comprising:
computer-executable program instructions to receive additional data comprising one or more interactions of a second kind by each of the one or more users with the one or more items of the first item type; and
computer-executable program instructions to augment the co-interaction matrix with additional rows and columns corresponding to the additional data.

10. The computer program product of claim 8, further comprising:
computer-executable program instructions to identify, from the extracted item embedding values, one or more geographically proximate item embedding values, the geographically proximate item embedding values comprising locations that are within a threshold distance from each other;
computer-executable program instructions to determine an average item embedding value for the identified one or more geographically proximate item embedding values; and
computer-executable program instructions to modify each of the extracted item embedding values based on the average item embedding value to generate a modified item embedding for each of the one or more geographically proximate item embedding values.

11. The computer program product of claim 8, further comprising:
computer-executable program instructions to determine, for each of the extracted item embedding values, a cosine distance between the respective item embedding value and each of the other extracted item embedding values; and
computer-executable program instructions to cluster, using a clustering algorithm, the extracted item embedding values into a hierarchy based on the determined cosine distances.

12. The computer program product of claim 8, further comprising:
computer-executable program instructions to determine, for each of the determined similarity values for the particular user, a greatest contributing factor to the determined similarity value based on the first item type interaction history for the particular user,
wherein the instructions for the user computing device to display the one or more ranked item search results include instructions to display the corresponding greatest contributing factor for each of the one or more ranked item search results.

13. The computer program product of claim 8, wherein the interaction of the first kind comprises completing a required number of interactive steps with a selected item and wherein the interaction of the second kind comprises one or more of a making a selection, submitting a review, and submitting a service request.

14. The computer program product of claim 8, wherein the first item type comprises a particular type of service and wherein the one or more items comprise venues offering the particular type of service.

15. A system to optimize item display on graphical user interfaces, comprising:
a storage device; and
a processor communicatively coupled to the storage device, wherein the processor executes application code instructions that are stored in the storage device to cause the system to:
receive a request to render a listing of item entries on a user interface of a user computing device;
analyze first item type interaction histories to determine item embedding values by:
receiving the first item type interaction histories for each of two or more users, the first item type interaction histories describing one or more interactions of a first kind by each of the two or more users with one or more items of a first item type;
generating a co-interaction matrix comprising rows and columns corresponding to each of the one or more items and matrix element values each representing a number of users determined to have the first kind of interaction with a row item of the corresponding row and a column item of the corresponding column within the co-interaction matrix;
generating an embeddings matrix comprising an item embedding value for each of the one or more items; and
extracting the item embedding value for each of the one or more items from the embeddings matrix;
analyze the first item type interaction histories to generate a user embedding value based on the first item type interaction history for a user associated with the user computing device;
generate the listing of item entries on the user interface of the user computing device by:
identifying each of the item entries that are responsive to the request to render the listing of item entries, the item entries comprising one or more corresponding items;
retrieving the item embedding value for each of the one or more item results;
determining similarity values corresponding to a similarity between the determined item embedding value for each of the one or more items and the generated user embedding value; and
ranking the one or more item results based on the determined similarity values, the ranking of the one or more item results comprising a preferred first item in a first position; and
render an optimized display of the one or more item results on the user interface of the user computing device, the optimized display comprising the preferred first item in the first position with each remaining item of the ranked one or more item results in a corresponding ranked non-first position

16. The system of claim 15, wherein the processor is further configured to execute computer-readable program instructions stored in the storage device to cause the system to:
receive additional data comprising one or more interactions of a second kind by each of the one or more users with the one or more items of the first item type; and
augment the co-interaction matrix with additional rows and columns corresponding to the additional data.

17. The system of claim 15, wherein the processor is further configured to execute computer-readable program instructions to cause the system to:
identify, from the extracted item embedding values, one or more geographically proximate item embedding values;
determine an average item embedding value for the identified one or more geographically proximate item embedding values; and
modify each of the extracted item embedding values based on the average item embedding value to generate a modified item embedding value for each of the one or more geographically proximate item embedding values.

18. The system of claim 15, wherein the processor is further configured to execute computer-readable program instructions to cause the system to determine, for each of the determined similarity values for the particular user, a greatest contributing factor to the determined similarity value based on the first item type interaction history for the particular user, wherein the instructions for the user computing device to display the one or more ranked item search results include instructions to display the corresponding greatest contributing factor for each of the one or more ranked item search results.

19. The system of claim 15, wherein the the interaction of the first kind comprises completing a required number of interactive steps with a selected item and wherein the interaction of the second kind comprises one or more of a making a selection, submitting a review, and submitting a service request.

20. The system of claim 15, wherein the first item type comprises a particular type of service and wherein the one or more items comprise venues offering the particular type of service.
